(19) United States
(12) Patent Application Publication
(10) Pub. No.: US 2019/0072400 A1
(43) Pub. Date: Mar. 7, 2019

(54) AUGMENTED RIDER IDENTIFICATION AND DYNAMIC REROUTING

(71) Applicant: GM Global Technology Operations LLC, Detroit, MI (US)

(72) Inventors: Spencer W. Chamberlain, Sterling Heights, MI (US); Clay A. Dean, Rochester, MI (US); Roy J. Mathieu, Rochester Hills, MI (US)

(21) Appl. No.: 15/693,857

(22) Filed: Sep. 1, 2017

(51) Int. Cl. G01C 21/34; G01C 21/36; B60R 25/25; G07C 9/00; G06K 9/00

(52) U.S. Cl. CPC G01C 21/3438; G01C 21/3602; G06K 9/00617; B60R 25/25; G07C 9/00158; G01C 21/3415

(57) ABSTRACT

Embodiments include methods, systems and computer readable storage medium for augmented rider identification and dynamic rerouting. The method includes presenting, by a processor, profile data associated with one or more potential passengers while a vehicle is en route to a passenger pickup location or at the passenger pickup location. The method further includes presenting, by the processor, image data obtained at the passenger pickup location. The method further includes comparing, by an occupant, the profile data and the obtained image data to confirm that the one or more potential passengers are at the passenger pickup location. The method further includes receiving, from the occupant, an entry input indicating that entry to the vehicle should or should not be allowed based on the comparison. The method further includes allowing or disallowing, by the processor, entry to the vehicle based on the received entry input.

### INTRODUCTION

The subject disclosure relates to rideshare services, and more specifically to identifying fellow rideshare passengers at pickup locations, altering pickup locations in a rideshare system and regulating access control of passengers.

Real-time ridesharing (also called dynamic, on-demand or instant ridesharing) is an automated service that matches drivers and users requesting one-way ridesharing services on very short notice. Real-time ridesharing (ridesharing) typically employs some form of navigation services/devices, applications for drivers to receive notifications for passenger pickup and applications for users to request ridesharing services. Ridesharing functionality in light of new technologies, for example, autonomous vehicles, are increasingly being considered.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles increasingly communicate with remote computer systems and with one another using V2X communications (Vehicle-to-Everything, Vehicle-to-Vehicle, Vehicle-to-Infrastructure).

Accordingly, it is desirable to provide a system that can allow a current rideshare occupant to identify potential rideshare passengers using an in-vehicle display, mobile device display or any other modality capable of providing identity information for potential rideshare passengers. As a result, the current rideshare occupant can verify approaching potential rideshare passengers, match an associated user profile and accept/reject entry of the approaching potential rideshare passengers into the rideshare vehicle.

### SUMMARY

In one exemplary embodiment, a method for augmented rider identification and dynamic rerouting is disclosed. The method includes presenting, by a processor, profile data associated with one or more potential passengers while a vehicle is en route to a passenger pickup location or at the passenger pickup location. The method further includes presenting, by the processor, image data obtained at the passenger pickup location. The method further includes comparing, by an occupant, the profile data and the obtained image data to confirm that the one or more potential passengers are at the passenger pickup location. The method further includes receiving, from the occupant, an entry input indicating that entry to the vehicle should or should not be allowed based on the comparison. The method further includes allowing or disallowing, by the processor, entry to the vehicle based on the received entry input.

In addition to one or more of the features described herein, one or more aspects of the described method can additionally include presenting a first location information associated with the passenger pickup location prior to arrival at the passenger pickup location. Another aspect can include receiving a location change input, wherein the location change input indicates second location information to be associated with the passenger pickup location that replaces the first location information. Another aspect can include notifying the one or more passengers of a location change input and the second location information. Additionally, the presentation of the profile data and the obtained image data is related to a direction associated with a gaze of the occupant. In addition, the vehicle described in the present method is an autonomous vehicle. Another aspect of the method can include filtering the obtained image data to identify the one or more passengers and presenting the filtered image data. Another aspect of the method can include confirming entry of the one or more passengers in the vehicle before leaving the passenger pickup location when entry to the vehicle is allowed.

In another exemplary embodiment, a system for augmented rider identification and dynamic rerouting is disclosed herein. The system includes a memory and processor in which the processor can present profile data associated with one or more potential passengers while a vehicle is en route to a passenger pickup location or at the passenger pickup location. The processor can further present image data obtained at the passenger pickup location. The processor can further receive an entry input indicating that entry to the vehicle should or should not be allowed based on a comparison of the profile data and the obtained image data. The processor can further allow or disallow entry to the vehicle based on the received entry input.

In yet another exemplary embodiment a computer readable storage medium for augmented rider identification and dynamic rerouting is disclosed herein. The computer readable storage medium includes presenting profile data associated with one or more potential passengers while a vehicle is en route to a passenger pickup location or at the passenger pickup location. The computer readable storage medium further includes presenting image data obtained at the passenger pickup location. The computer readable storage medium further includes comparing the profile data and the obtained image data to confirm that the one or more potential passengers are at the passenger pickup location. The computer readable storage medium further includes receiving an entry input indicating that entry to the vehicle should or should not be allowed based on the comparison. The computer readable storage medium further includes allowing or disallowing entry to the vehicle based on the received entry input.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts an in-vehicle display associated with augmented rider identification and dynamic rerouting according to one or more embodiments; and

FIG. 4 is a flow diagram of a method for augmented rider identification and dynamic rerouting according to one or more embodiments.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

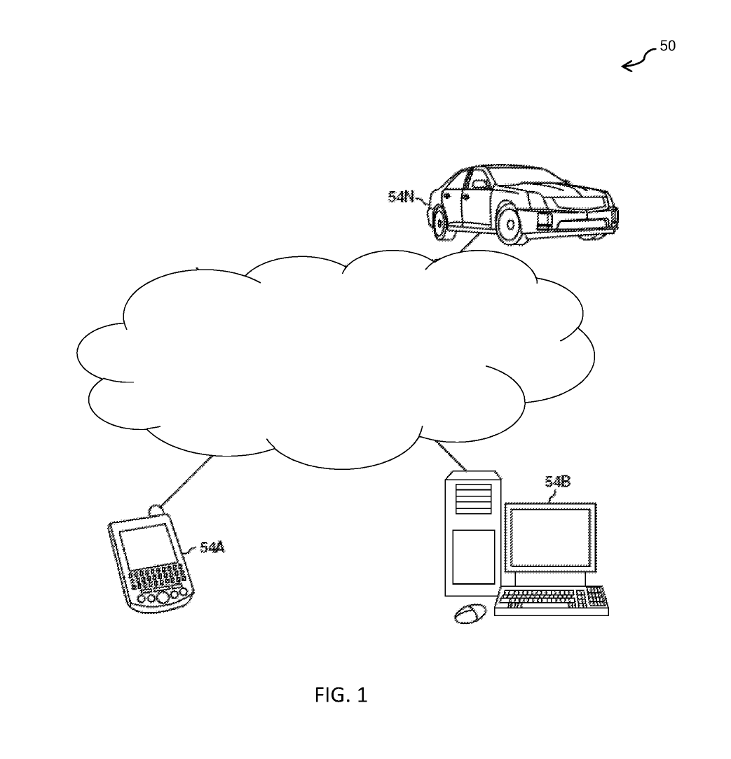

In accordance with an exemplary embodiment, FIG. 1 illustrates a computing environment 50 associated with an augmented rider identification and dynamic rerouting system. As shown, computing environment 50 comprises one or more computing devices, for example, personal digital assistant (PDA) or cellular telephone (mobile device) 54A, server 54B, and/or vehicle on-board computer system 54N, which are connected via network 150. The one or more computing devices may communicate with one another using network 150.

Network 150 can be, for example, a local area network (LAN), a wide area network (WAN), such as the Internet, a dedicated short range communications network, or any combination thereof, and may include wired, wireless, fiber optic, or any other connection. Network 150 can be any combination of connections and protocols that will support communication between mobile device 54A, server 54B, and/or vehicle on-board computer system 54N, respectively.

The mobile device 54A and vehicle associated with the vehicle on-board computer system 54N can include a GPS transmitter/receiver (not shown) which is operable for receiving location signals from the plurality of GPS satellites (not shown) that provide signals representative of a location for each of the mobile resources, respectively. In addition to the GPS transmitter/receiver, the mobile device 54A and vehicle associated with the vehicle on-board computer system 54N may include a navigation processing system that can be arranged to communicate with a server 54B through the network 150. Accordingly, the mobile device 54A and vehicle associated with the vehicle on-board computer system 54N are able to determine location information and transmit that location information to the server 54B.

Additional signals sent and received may include data, communication, and/or other propagated signals. Further, it should be noted that the functions of transmitter and receiver could be combined into a signal transceiver.

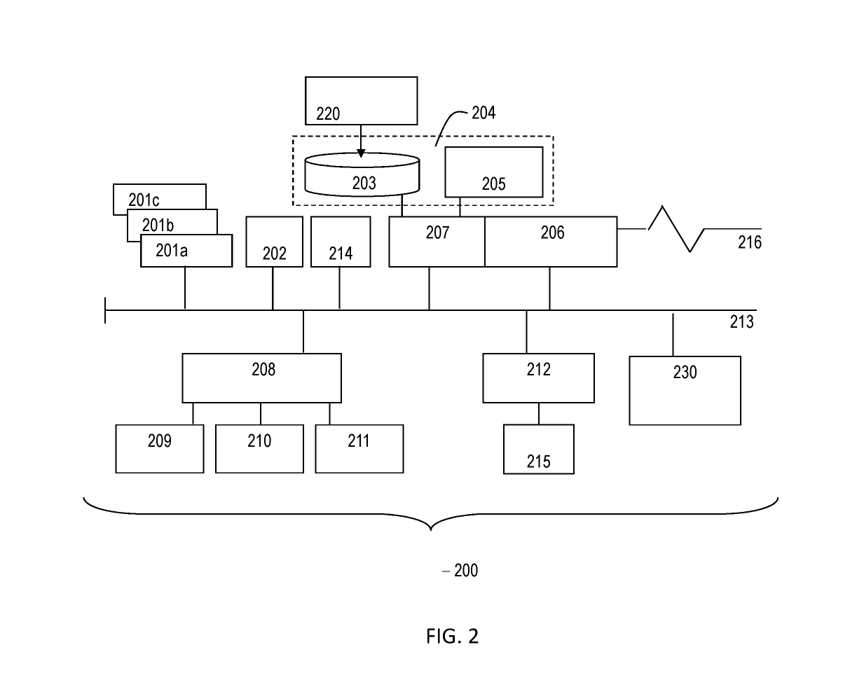

In accordance with an exemplary embodiment, FIG. 2 illustrates a processing system 200 for implementing the teachings herein. The processing system 200 can form at least a portion of the one or more computing devices, such as mobile device 54A, server 54B, and/or vehicle on-board computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 150 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

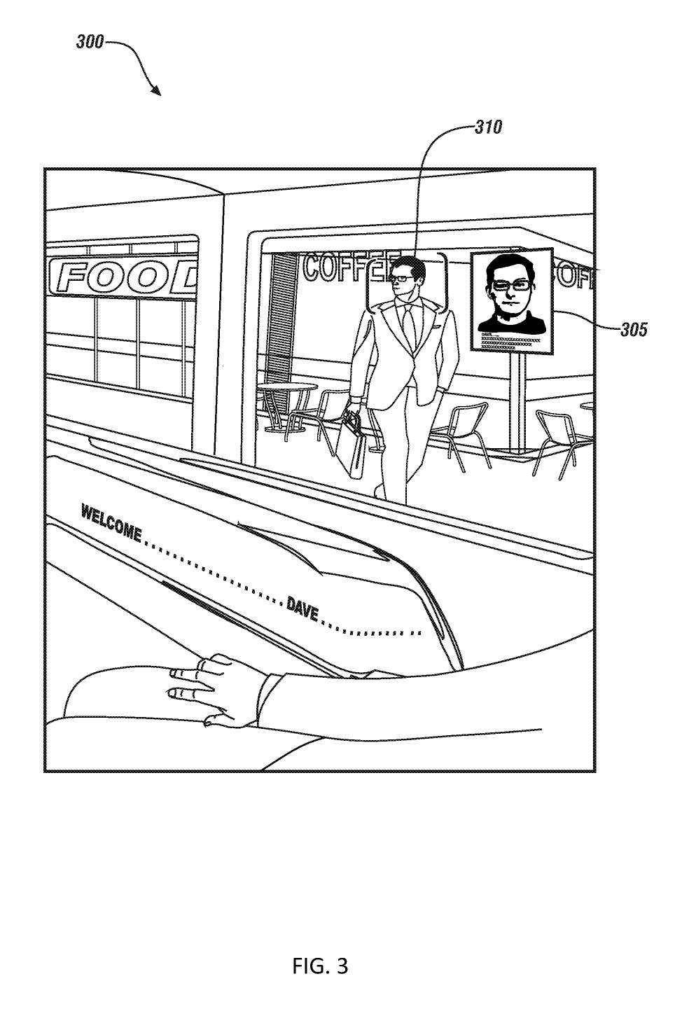

In accordance with an exemplary embodiment, FIG. 3 depicts an in-vehicle display associated with a rideshare vehicle containing vehicle on-board computer system 54N, for example, display 215. Display 215 can be an augmented display and provide a variety of information to a rideshare occupant. Display 215 can exist on any portion of the rideshare vehicle. The rideshare vehicle can contain sensors to track a current rideshare occupant's gaze and display information at a location within the rideshare vehicle consistent with the current rideshare occupant's gaze.

Information presented on display 215 can be related to potential rideshare passengers scheduled for pickup by the rideshare vehicle. For example, image data 305 (i.e., static images, video, biometric data or any other data that can be used for recognition of an individual) of one or more potential rideshare passengers can be displayed on display 215 for review by a current rideshare occupant. Profile data 310 (i.e., an image, video or non-image data, such as behavioral data like biometrics, walking gait, etc.) associated with the one or more potential rideshare passengers can also be displayed on display 215 for review by a current rideshare occupant. The profile data 310 can be associated with a user profile of a rideshare application stored on server 54B. Accordingly, the current rideshare occupant can be informed of other rideshare passengers scheduled to share the rideshare vehicle with the current rideshare occupant prior to entry of the rideshare vehicle by the other rideshare passengers. The rideshare passenger information can be presented to the current rideshare occupant prior to arrival at a pickup location for the other rideshare passengers.

Other information presented on display 215 can be related to image data can be obtained from one or more on-board sensors associated with the rideshare vehicle or off-board inputs, for example, data obtained from cameras/sensors of mobile devices or an infrastructure (traffic camera, security camera, etc.). For example, the one or more sensors can be visual sensors used to obtain images of individuals near the rideshare vehicle. The vehicle on-board computer system 54N can filter the obtained images and determine if one or more potential rideshare passengers scheduled to enter the rideshare vehicle exist within the obtained images, i.e., obtain image data 305 for the one or more potential rideshare passengers scheduled from the obtained images of individuals near the rideshare vehicle. If image data 305 for the one or more potential rideshare passengers scheduled to enter the rideshare vehicle exist, the obtained image data 305 can be presented on display 215 along with the profile data 310 of the one or more potential rideshare passengers scheduled to enter the rideshare vehicle for comparison by the current rideshare occupant.

The current rideshare occupant can view, on display 215, both the image data 305 and profile data 310 and indicate whether the current rideshare occupant is comfortable with allowing the one or more potential rideshare passengers scheduled to enter the rideshare vehicle entry to the rideshare vehicle. Accordingly, the current rideshare occupant can accept or reject entry of the one or more potential rideshare passengers scheduled to enter the rideshare vehicle. The acceptance or rejection of the one or more potential rideshare passengers scheduled to enter the rideshare vehicle can be input via display 215, keyboard 209, mouse 210, speaker 211 or the like. The interaction between the current rideshare passenger and display 215 to accept or reject entry of the one or more potential rideshare passengers scheduled to enter the rideshare vehicle can also occur via mobile device 54A instead of display 215.

In addition, the computing environment 50 associated with an augmented rider identification and dynamic rerouting system can display pickup locations associated with one or more potential rideshare passengers scheduled to enter the rideshare vehicle and enable the current rideshare occupant to reroute/redirect the rideshare vehicle from an original pickup location to a new pickup location. The reroute/redirect could occur using natural speech recognition, natural gestures, visual human machine interface (HMI) interaction or the like. For example, if a pickup location is considered dangerous or remote by the current rideshare occupant, the occupant can redirect the rideshare vehicle to a new location deemed less dangerous or remote. The vehicle on-board computer system 54N can notify server 54B of the changed pickup location, which can notify the one or more potential rideshare passengers scheduled to enter the rideshare vehicle of the changed pickup location. Server 54B can also reroute/redirect the rideshare vehicle from an original pickup location based on a current location of the one or more potential rideshare passengers scheduled to enter the rideshare vehicle. For example, the one or more potential rideshare passengers can be located at a venue with multiple exits (a stadium or the like). While a pickup location may be slated for a given exit, it may be more efficient from many perspectives, for example, a faster exit from the venue, to have the pickup occur at a different exit. Accordingly, server 54B can notify the one or more potential rideshare passengers of the changed pickup location.

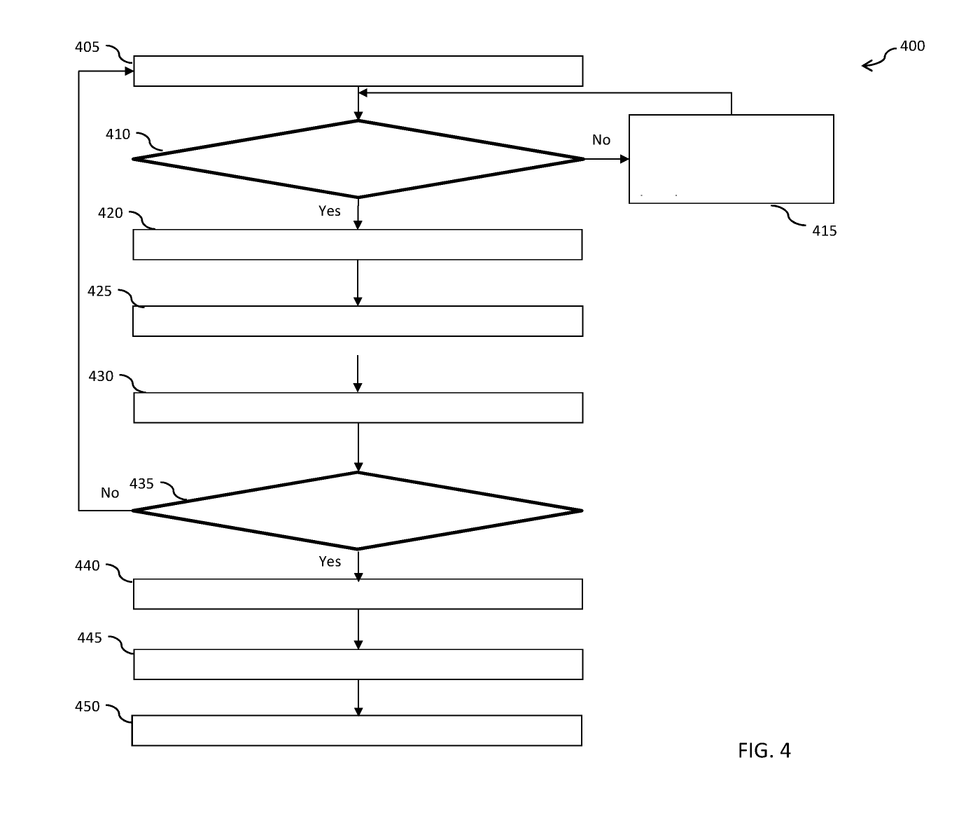

In accordance with an exemplary embodiment, FIG. 4 depicts a flow diagram of a method for augmented rider identification and dynamic rerouting 400. At block 405, a pickup location associated with potential rideshare passengers is presented to a current rideshare occupant. At block 410, the current rideshare occupant can indicate whether the presented pickup location is acceptable. If the presented pickup location is not acceptable to the current rideshare occupant, the method proceeds to block 415 where the rideshare vehicle can be relocated/rerouted to another pickup location.

If the presented pickup location is acceptable to the current rideshare occupant, the method proceeds to block 420 where the rideshare vehicle can travel to the presented pickup location and monitor an area around the rideshare vehicle for the potential rideshare passengers. At block 425, the rideshare vehicle can use on-board sensors to collect image data of individuals around the rideshare vehicle, which can be filtered to identify image data associated with the one or more potential passengers near the rideshare vehicle. At block 430, the filtered image data associated with the one or more potential passengers and profile data associated with the one or more potential passengers can be presented to the current rideshare occupant.

At block 435, the current rideshare occupant can view both the filtered image data and profile data associated with the one or more potential passengers and determine whether to allow entry to the rideshare vehicle. If the current rideshare occupant determines that entry to the rider share vehicle by the one or more potential passengers is not permitted, the method returns to block 405. If the current rideshare occupant determines that entry to the rider share vehicle by the one or more potential passengers is permitted, the method proceeds to block 440 where access to the rideshare vehicle can be provided to the one or more potential passengers.

At block 445, the rideshare vehicle can use on-board sensors to confirm entry of the one or more potential passengers to the rideshare vehicle. At block 450, the rideshare vehicle can resume travel.

Accordingly, the embodiments disclosed herein describe a system that can identify potential passengers through an augmented display in a vehicle. Occupants inside can compare and verify vehicle obtained image data with profile data related to potential passengers. The occupants can permit or deny entry to the vehicle based on the comparison and verification. In addition, the occupants can reroute the vehicle to a different pickup location if desired.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment 50 is associated with an augmented rider identification and dynamic rerouting system that can be implemented in a cloud computing environment, and pickup location information, routing/re-routing information, profile data/and or obtained image data can be stored locally and/or remotely, such as in the cloud computing environment.

Technical effects and benefits of the disclosed embodiments include, but are not limited to providing enhanced safety for rideshare occupants.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for augmented rider identification and dynamic rerouting, the method comprising:
presenting, by a processor, profile data associated with one or more potential passengers while a vehicle is en route to a passenger pickup location or at the passenger pickup location;
presenting, by the processor, image data obtained at the passenger pickup location;
comparing, by an occupant, the profile data and the obtained image data to confirm that the one or more potential passengers are at the passenger pickup location;
receiving, from the occupant, an entry input indicating that entry to the vehicle should or should not be allowed based on the comparison; and
allowing or disallowing, by the processor, entry to the vehicle based on the received entry input.

2. The method of claim 1 further comprising presenting a first location information associated with the passenger pickup location prior to arrival at the passenger pickup location.

3. The method of claim 2 further comprising receiving a location change input, wherein the location change input indicates a second location information to be associated with the passenger pickup location that replaces the first location information.

4. The method of claim 3 further comprising notifying the one or more passengers of location change input and the second location information.

5. The method of claim 1, wherein the presentation of the profile data and the obtained image data is related to a direction associated with a gaze of the occupant.

6. The method of claim 1, wherein the vehicle is an autonomous vehicle.

7. The method of claim 1 further comprising filtering the obtained image data to identify the one or more passengers and presenting the filtered image data.

8. The method of claim 1 further comprising confirming entry of the one or more passengers in the vehicle before leaving the passenger pickup location when entry to the vehicle is allowed.

9. A system for augmented rider identification and dynamic rerouting, the system comprising:
a memory; and
a processor coupled to the memory, wherein the processor is operable to:
present profile data associated with one or more potential passengers while a vehicle is en route to a passenger pickup location or at the passenger pickup location;
present image data obtained at the passenger pickup location;
receive an entry input indicating that entry to the vehicle should or should not be allowed based on a comparison of the profile data and the obtained image data; and
allow or disallow entry to the vehicle based on the received entry input.

10. The system of claim 9 wherein the processor is further operable to present a first location information associated with the passenger pickup location prior to arrival at the passenger pickup location.

11. The system of claim 10 wherein the processor is further operable to receive a location change input, wherein the location change input indicates a second location information to be associated with the passenger pickup location that replaces the first location information.

12. The system of claim 11 wherein the processor is further operable to notify the one or more passengers of location change input and the second location information.

13. The system of claim 9, wherein the presentation of the profile data and the obtained image data is related to a direction associated with a gaze of the occupant.

14. The system of claim 9, wherein the vehicle is an autonomous vehicle.

15. The system of claim 9 wherein the processor is further operable to filter the obtained image data to identify the one or more passengers and presenting the filtered image data.

16. The system of claim 9 wherein the processor is further operable to confirm entry of the one or more passengers in the vehicle before leaving the passenger pickup location when entry to the vehicle is allowed.

17. A non-transitory computer readable storage medium having program instructions embodied therewith, the program instructions readable by a processor to cause the processor to perform a method for augmented rider identification and dynamic rerouting comprising:
presenting profile data associated with one or more potential passengers while a vehicle is en route to a passenger pickup location or at the passenger pickup location;
presenting image data obtained at the passenger pickup location;
comparing the profile data and the obtained image data to confirm that the one or more potential passengers are at the passenger pickup location;
receiving an entry input indicating that entry to the vehicle should or should not be allowed based on the comparison; and
allowing or disallowing entry to the vehicle based on the received entry input.

18. The computer readable storage medium of claim 17 further comprising presenting a first location information associated with the passenger pickup location prior to arrival at the passenger pickup location.

19. The computer readable storage medium of claim 18 further comprising receiving a location change input, wherein the location change input indicates a second location information to be associated with the passenger pickup location that replaces the first location information.

20. The computer readable storage medium of claim 18 further comprising notifying the one or more passengers of location change input and the second location information.
